(19) United States
(12) Patent Application Publication
(10) Pub. No.: US 2025/0117112 A1
(43) Pub. Date: Apr. 10, 2025

(54) Overlay Bubble Messaging User Interface

(71) Applicant: Juergen Koehler, Algermissen (DE)

(72) Inventor: Juergen Koehler, Algermissen (DE)

(21) Appl. No.: 18/984,919

(22) Filed: Dec. 17, 2024

Related U.S. Application Data
(63) Continuation-in-part of application No. 18/408,275, filed on Jan. 9, 2024, now Pat. No. 12,170,699.
Application No. 18/408,275 is a continuation-in-part of application No. 18/194,470, filed on Mar. 31, 2023, now Pat. No. 11,871,153.
Application No. 18/194,470 is a continuation-in-part of application No. 29/875,242, filed on May 1, 2023.

(51) Int. Cl. G06F 3/0482; G06F 3/04812; H04L 51/04; H04N 7/15

(52) U.S. Cl. CPC G06F 3/0482; G06F 3/04812; H04L 51/04; H04N 7/157

(57) ABSTRACT

A system and method provided for integrating communication functionalities with primary application activities on electronic devices, featuring an overlay graphical user interface for video and call bubbles, asynchronous and synchronous messaging, and adjustable visibility controls to prevent interference with primary applications. In one aspect, the system integrates communication tools within a primary application environment on an electronic device. The overlay interface is configured to float above all active windows, providing continuous visibility of communication functionalities such as video and call bubbles without obstructing primary application tasks.

The current application is a continuation-in-part (CIP) application of the U.S. non-provisional utility application Ser. No. 18/408,275 filed on Jan. 9, 2024. The U.S. non-provisional utility application Ser. No. 18/408,275 is a CIP application of the U.S. non-provisional design application Ser. No. 29/875,242 filed on May 1, 2023. The U.S. non-provisional utility application Ser. No. 18/408,275 is also a CIP application of the U.S. non-provisional utility application Ser. No. 18/194,470 filed on Mar. 31, 2023.

### FIELD OF THE INVENTION

The present invention relates generally to graphical user interfaces (GUIs) for integrating communication tools within primary application environments on various operating systems, including Mac OS (operating systems) and Windows OS. More specifically, the present invention facilitates seamless interaction with asynchronous and synchronous messages, encompassing text, audio, and video formats, through an overlay interface that enhances user productivity and maintains workflow continuity.

### BACKGROUND OF THE INVENTION

Graphical user interfaces (GUIs) for accessing, composing, manipulating, and sharing electronic messages suffer from several inefficiencies that impact user productivity and experience. Current techniques often necessitate navigating through complex and time-consuming interfaces, which can deter users from efficiently performing their tasks. This is particularly problematic for users who need to switch between different applications and communication tools. The usability of these GUIs is crucial as users increasingly rely on electronic devices for both communication and productivity tasks.

The issue is exacerbated by the high amount of time employees spend on communication activities versus creative tasks. According to the 2023 Microsoft Work Trend Index Annual Report, employees allocate a significant portion of their workweek to emails and online meetings. Frequent application window switching further aggravates the problem, leading to substantial time loss and cognitive overhead. Research indicates that such toggling between different apps and websites can result in considerable disruptions, with an estimated 20-25% of these switches occurring between communication and productivity applications. This frequent toggling not only consumes valuable time but also increases the likelihood of errors and cognitive fatigue. Additionally, the integration of communication functions within other applications has been attempted, but these efforts often fall short of user expectations. Specific applications like Figma or Google Docs incorporate communication features, yet users continue to toggle between these integrated solutions and other communication platforms. This incomplete integration results in dissatisfaction and persistent interruptions.

The cognitive load induced by constant decision-making for mundane tasks, such as deciding when and how to toggle between applications, further contributes to reduced efficiency. Harvard Business Review reports that repetitive decisions related to task switching can deplete cognitive resources, detracting from more valuable tasks that require critical thinking and creativity. Asynchronous communication modes, including text, audio, and video, aim to offset the burden of synchronous online meetings but still require seamless transitions between different interactive methods to be effective. What is needed is a system that addresses these inefficiencies by providing a unified graphical user interface that supports accessing, composing, manipulating, and sharing electronic messages while allowing users to perform primary activities without frequent toggling or context switching. Such a system should integrate communication tools directly within the primary application environment, thereby increasing productivity, reducing cognitive fatigue, and enhancing overall user satisfaction.

An objective of the present invention is to provide a system and a method for integrating communication functionalities with primary application activities on electronic devices, featuring an overlay graphical user interface for video and call bubbles, asynchronous and synchronous messaging, and adjustable visibility controls to prevent interference with primary applications. Further, the present invention is a system for integrating communication functionalities into primary application activities via an overlay graphical user interface, facilitating asynchronous and synchronous messaging, visibility control, and dynamic adjustment to prevent interference with primary applications.

### SUMMARY OF THE INVENTION

The present invention provides a system and a method for integrating communication functionalities with primary application activities on electronic devices, featuring an overlay graphical user interface for video and call bubbles, asynchronous and synchronous messaging, and adjustable visibility controls to prevent interference with primary applications. In one aspect, the system integrates communication tools within a primary application environment on an electronic device. The overlay interface is configured to float above all active windows, providing continuous visibility of communication functionalities such as video and call bubbles without obstructing primary application tasks.

One object of the system is to streamline user interactions by embedding communication tools directly into the user's workflow, which minimizes the need for switching between application windows, thereby enhancing productivity. In an embodiment, asynchronous messaging is enabled via movable text, audio, and video message bubbles. These bubbles can dynamically appear on top of all windows or remain accessible through an inbox.

Another object of the system is to improve collaborative efforts during live communication. The system supports live video and audio calls within the overlay interface and includes features like screen recording, screen sharing, and pointer control. In another embodiment, the system dynamically adjusts the visibility of the overlay interface to avoid interference with primary applications. Users can hide or reveal the communication interface through different input methods such as app icons, floating icons, or taskbar icons.

Yet another object of the system is to enhance user control over message interactions. This includes the ability for recipients to control the bubble's position and transitions such as swirling, blinking, or bouncing, ensuring minimal disruption to ongoing tasks.

In another embodiment, messages are contextually linked to specific files or applications. This utilizes file hashing techniques to maintain contextual relevance across different versions and user environments, providing a seamless user experience across diverse scenarios.

Additionally, the system ensures secure data handling by employing encryption techniques for messages, whether stored locally, on a server, or streamed. This includes separate storage files for screen capture, video capture, and positional data, synchronized during playback via a custom player.

The system also reduces cognitive load and physical fatigue by enabling customizable defaults for message bubble positions, visibility preferences, size, and audio settings, allowing for a tailored user experience while maintaining communication efficacy.

### BRIEF DESCRIPTION OF THE DRAWINGS

FIG. 1 is a schematic view showing the overall system of the present invention.

FIG. 2 is a schematic view of the present invention, showing a main screen arrangement of a primary window, a plurality of bubble messaging overlays, and parts of a computer screen, of a user named John.

FIG. 3 is a flowchart depicting an overall process of a method of the present invention, wherein message interactions and management of an overlay interface according to a preferred embodiment are listed.

FIG. 4 is a schematic view of the present invention showing a main screen of the user John, wherein a message viewing interaction overlay with action menu options are depicted.

FIG. 5 is a schematic view of the present invention showing a main screen of the user John, wherein a call interaction between John and another user Jane with action indicator is depicted.

FIG. 6 is a schematic view of the present invention showing a main screen of the user Jane, wherein a call interaction between John and user Jane with status indicator is depicted.

FIG. 7 is a schematic view of the present invention showing a main screen of the user John, wherein a video recording in progress with action menu is depicted.

FIG. 8 is a schematic view of the present invention showing a main screen of the user John, wherein a call bubble drag-and-drop across shared windows is shown.

FIG. 9 is a schematic view of the present invention showing a main screen of the user John, wherein a message preview overlay with toggle view option is shown.

FIG. 10 is a schematic view of the present invention showing a main screen of the user John, wherein a final state of the pointers after presenter control transition is shown.

FIG. 11 is a schematic view of the present invention showing a main screen of the user John, wherein a call bubble of a presenter with grouped call bubbles is shown.

FIG. 12 is a flowchart depicting a sub-process of the present invention, wherein layering a contact bubble over an active application window is discussed.

FIG. 13 is a flowchart depicting a sub-process of the present invention, flexible motion of overlay bubbles across the screen is discussed.

FIG. 14 is a flowchart depicting a sub-process of the present invention, wherein working of a ‘new’ action button is discussed.

FIG. 15 is a flowchart depicting a sub-process of the present invention, wherein initiation of a communication line with the click of an overlay contact bubble is discussed.

FIG. 16 is a flowchart depicting a sub-process of the present invention, wherein working of a ‘close’ action button is discussed.

FIG. 17 is a flowchart depicting a sub-process of the present invention, wherein working of a ‘list-view’ action button is discussed.

FIG. 18 is a flowchart depicting a sub-process of the present invention, wherein working of a ‘bubble-view’ action button is discussed.

FIG. 19 is a flowchart depicting a sub-process of the present invention, wherein transitioning of a default cursor during a virtual conference session is discussed.

FIG. 20 is a flowchart depicting a sub-process of the present invention, wherein appearance of a notification indicator over a contact bubble on receiving a new message/information is discussed.

FIG. 21 is a flowchart depicting a sub-process of the present invention, wherein grouping of primary contacts is discussed.

FIG. 22 is a flowchart depicting a sub-process of the present invention, wherein grouping of overlay contact bubbles is discussed.

### DETAILED DESCRIPTION OF THE INVENTION

All illustrations of the drawings are for the purpose of describing selected versions of the present invention and are not intended to limit the scope of the present invention.

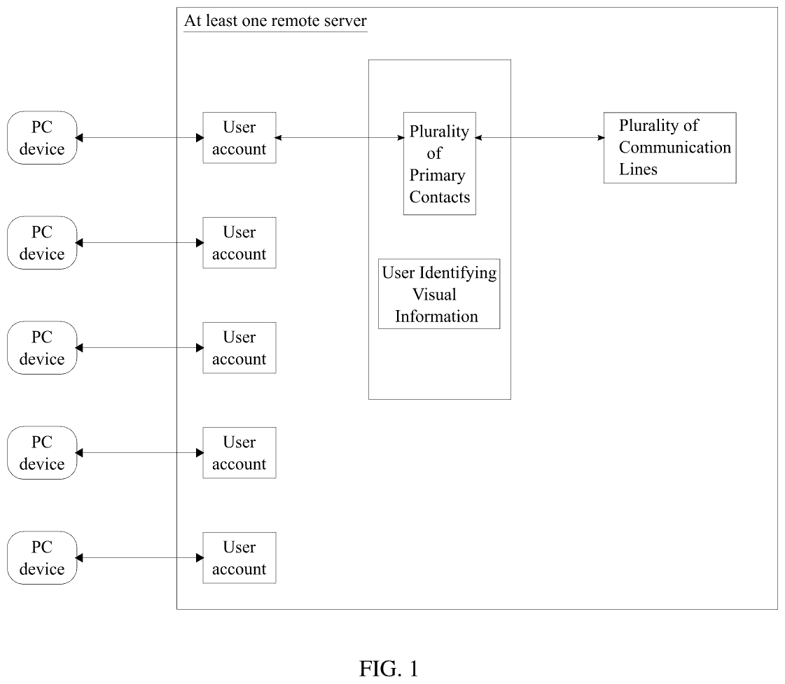

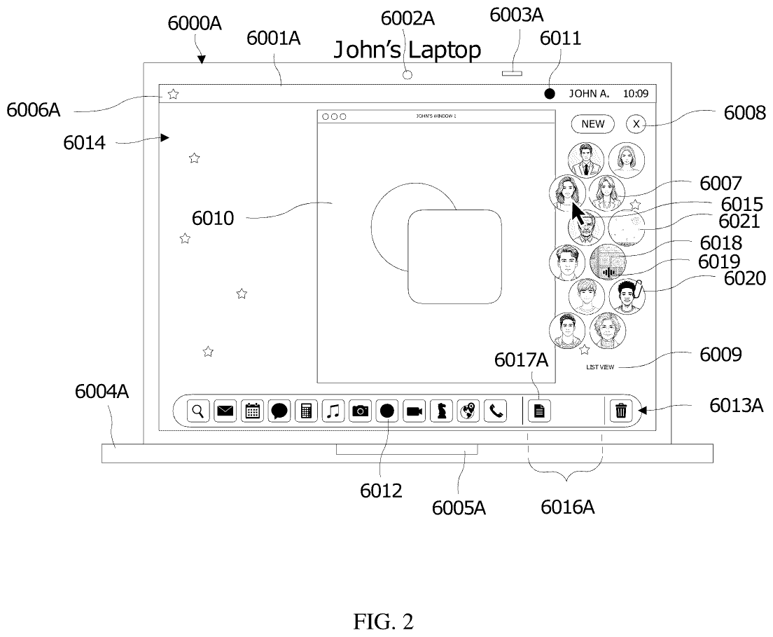

The present invention is a system and a method of managing a graphic user interface (GUI) for a messaging service with overlaying contact bubbles. More specifically, the present invention provides a system and a method for integrating communication functionalities with primary application activities on electronic devices, featuring an overlay graphical user interface for video and call bubbles, asynchronous and synchronous messaging, and adjustable visibility controls to prevent interference with primary applications. As can be seen in FIG. 1 and FIG. 2, the system used to implement the method of the present invention includes a plurality of communication lines and at least one remote server (Step A). Preferably, the communication lines and a plurality of user accounts are managed by the remote server. The communication lines are the different ways of electronic communication amongst the user accounts (e.g., video conference, messaging, etc.) and the remote server is used to facilitate communication between the user accounts and manage other shared functionalities of the present invention amongst the user accounts. Moreover, the remote server is used to execute a number of internal processes for the present invention and is used to store message data. Each user account is associated with a corresponding user personal computing (PC) device. More specifically, each user account allows a single unique user who is able to interact, participate, and operate the present invention with the corresponding PC device. The corresponding user PC device can be, but is not limited to, a computerized mobile phone (i.e., a “smart-phone”), a laptop, a desktop, or a tablet PC, AV eye and touch interfaces. To that end, the present invention works on operating systems, mobile applications, and/or may be embedded into websites.

Further, each user account includes user-identifying visual information and a plurality of primary contacts, and each primary contact is associated to a corresponding user account from the plurality of user accounts. The user-identifying visual information is preferably a profile picture of the user. However, the user-identifying visual information may additionally or alternatively include any other kinds of user-identifying information (e.g., the user's initials, any other user-preferred picture, symbol, etc.). In some embodiments of the present invention, at least two users accounts can use their corresponding PC devices to directly communicate with each other (i.e., a peer-to-peer functionality) instead of indirectly relaying communication through the remote server.

FIG. 2 provides an overview of the user interface on John's device (6000A), showcasing the bubble message app and its interactive features. The interface is designed with flexibility, allowing users to interact with bubble messages or overlaying bubble contact (e.g., 6007, 6018, 6021), toggle between different views (e.g., 6009), and access additional functionality through the primary menu overlay (6008). Additional embodiments and transitions: The shape, size, shadow, and background of bubble messages (e.g., 6007, 6018, 6021) may be customized by the user in the settings dialog. Users can also set the alignment and position of the bubbles on the screen. The labels found in FIG. 2 are for the following:
6000A: John's device (e.g., a laptop)
6001A: Display
6002A: One or more cameras
6003A: One or more microphones
6004A: Keyboard
6005A: Trackpad
6006A: Menu bar (or status bar)
6007: Video bubble message thumbnail overlay (e.g., round shape, static or animated)
6008: Bubble message app primary menu overlay (e.g., call, message, search, tags, filter, settings, hide, exit)
6009: Bubble message app toggle view overlay (e.g., toggle bubble view, list view)
6010: John's Window 1 (e.g., text app, or shared content space)
6011: Bubble messages status icon (e.g., opens bubble messages)
6012: Bubble messages app icon (e.g., opens bubble messages)
6013A: Dock
6014A: Desktop window (e.g., screen 1)
6015: John's Input (e.g., a mouse click)
6016A: Dynamic region
6017A: Text app icon
6018: Audio bubble message thumbnail overlay (e.g., voice recording with profile photo, screenshot, or screen recording)
6019: Message type indicator (e.g., audio waveform icon)
6020: Sharing indicator (attached file or shared content access, e.g., paper clip icon)
6021: Screen recording video bubble message thumbnail overlay (static or animated)

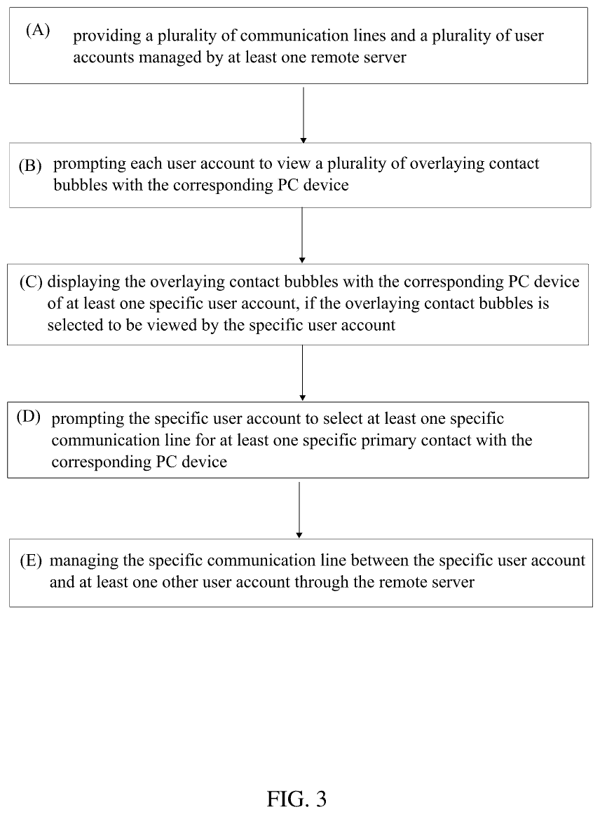

As can be seen in FIG. 3, the method of the present invention follows an overall process for managing a GUI for a messaging service with overlaying contact bubbles. The overall process begins by prompting each user account to view a plurality of overlaying contact bubbles with the corresponding PC device (Step B). The overlaying contact bubbles are graphic interactive circular elements that represent each contact user, allowing the specific user account to interact with the plurality of user accounts, as well as shows an overlaying intimation about various message notifications and interactions between users. In other words, overlay messages, also referred to as Interactive Contact Bubbles or Overlay Face, are dynamic and persistent graphical elements that provide users with seamless communication options across text, voice, video, file sharing, and screen recording. These interactive bubbles appear as overlays on the primary workspace or content, enhancing productivity by reducing context switching and enabling intuitive access to communication tasks. Overlay Messages include context menu actions, such as Call, Reply with Video, Reply with Audio, Record Screen, and Share Screen. They are designed to adapt dynamically to reading direction (LTR and RTL), user input methods (e.g., gestures, mouse, and gaze), and screen layouts, ensuring consistency and usability across macOS, iOS, iPadOS, and vision OS. More specifically, overlay messages are versatile and integrate seamlessly into Apple's ecosystem:
macOS: Overlay Messages appear over active application windows, supporting multi-monitor environments and respecting workspace boundaries.
iOS and iPadOS: They adapt to touch-based interactions, offering gestures like swipe-to-dismiss, pinch-to-resize, and drag-to-group.
vision OS: In AR/VR environments, Overlay Messages persist in spatial layouts and are controllable through hand gestures, gaze tracking, and natural inputs.

Overlay Messages maintain consistency across devices, scaling dynamically to suit different screen sizes and interaction paradigms.

It should be noted that the shape, size, shadow, and background of bubble messages (e.g., 6007, 6018, 6021) can be customized by the user in the settings dialog. In other words, bubbles can be of various shapes and can have names inside or below them. If the user needs an indication without having to touch or overlay pointer. Users can also set the alignment and position of the bubbles on the screen. Shapes for the overlaying contact bubbles can be, but are not limited to, circular bubbles, rectangular tiles, stacked messages, or a variety of other shapes. In case of AR/VR (augmented reality/virtual reality) devices the contact bubble can also be an AI agent. In such cases, gestures enable bubble interactions, including drag-and-drop to initiate calls, start/stop screen sharing, and reposition bubbles across screens. Thus, when an artificial intelligence model is managed by the remote server, the at least one response, at least one transcription, at least one summary, or a combination thereof is generated by the artificial intelligence model.

The overall process continues by displaying the overlaying contact bubbles with the corresponding PC device of at least one specific user account, if the overlaying contact bubble is selected to be viewed by the specific user account (Step C). Moreover, the specific user account is from the plurality of user accounts, and the user-identifying visual information of each primary contact for the specific user account is displayed within a corresponding overlaying contact bubble from the plurality of overlaying contact bubbles. For example, in FIG. 2, 6007 represents a video bubble message overlay, and 6020 represents another overlay contact bubble of another user contact.

The overall process continues by prompting the specific user account to select at least one specific communication line for at least one specific primary contact with the corresponding PC device (Step D). Further, the specific communication line is from the plurality of communication lines, and the specific primary contact is from the plurality of primary contacts for the specific user account. The specific communication line is any mode of virtual communication (e.g., text message, voice recording, video recording, etc.). In other words, the present invention uses interactive elements including movable and customizable bubbles for text, audio, video, or screen-sharing messages that are dynamically adjustable based on the user's interaction content.

The overall process continues by managing the specific communication line between the specific user account and at least one other user account through the remote server (Step E). The other user account is the corresponding user account of the specific user contact. In other words, the present invention enables cross-platform synchronous communication capabilities, including live video and audio calls, screen sharing, and interactive pointer control, integrated seamlessly into the user interface. Further, asynchronous communication functionalities are also made possible, thereby allowing the creation, transmission, and display of text, audio, video, or screen recordings as persistent overlays across the aforementioned platforms. Synchronous messaging refers to real-time communication where both parties are actively engaged in a conversation at the same time, like a live chat or phone call, while asynchronous messaging” means sending messages that can be received and responded to at different times, allowing for delays between replies, like email or leaving a message on a forum. For example, in one scenario, the specific communication line is at least one textual message sent between the specific user account and the other user account during Step E. In another scenario, the specific communication line is at least one audio message sent between the specific user account and the other user account during Step E. In yet another scenario, the specific communication line is at least one video message sent between the specific user account and the other user account during Step E. In yet another scenario, the specific communication line is a virtual conference session held between the specific user account and the other user account during Step E. However, during execution of any of specific communication lines, a graphic seamless transition is executed by the remote server while switching from the specific communication line to another communication line, if the specific user account selects to switch from the specific communication line to the other communication line, wherein the other communication line is from the plurality of communication lines. In other words, the present invention enables seamless transition and integration of actions while dynamically transitioning between video replay, video call, and screen recording modes in response to user input.

The following are descriptions of example user interactions using the overlay interface, according to a preferred embodiment of the present invention.

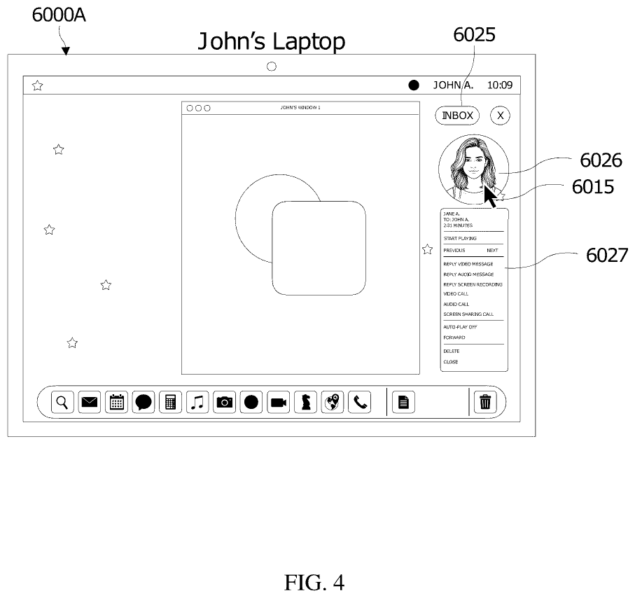

FIG. 4 depicts a message interaction overlay with action menu options. Labels and details for FIG. 4 are as follows:

### Labels

6000A: John's device (e.g., a laptop)
6025: Action button to return to inbox view (bubble view or list view)
6026: Message overlay (e.g., profile photo with audio, video, screenshot, or screen recording content; can be static or auto-play, play once or loop, interact with overlay to play and pause playing)
6015: Input (e.g., a mouse click to interact with message options)
6027: Open message action menu overlay (e.g., options like start playing, reply video message, reply audio message, reply screen recording, video call, audio call, screen sharing call, auto-play off, forward, delete, archive, close)

### Description

FIG. 4 illustrates the user interacting with a message displayed on John's device (6000A). The message overlay (6026) allows John to view content such as a profile photo with audio, video, or screen recording. John can click (6015) to interact with the message options, activating the action menu overlay (6027), which provides a range of actions like replying with different formats (video, audio, screen recording), initiating a video or audio call, or sharing the screen.

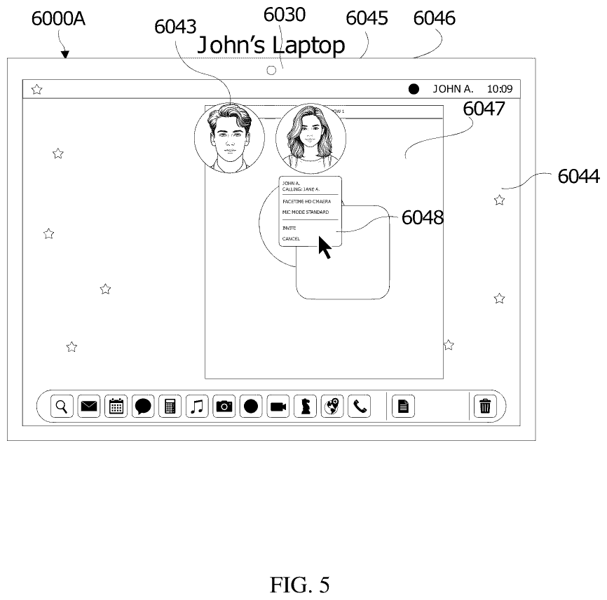

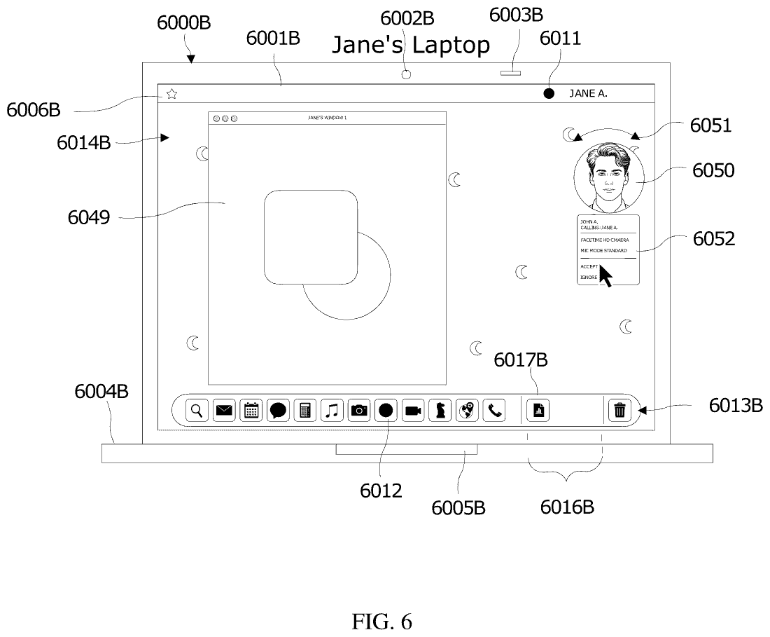

FIG. 5 and FIG. 6 illustrate an interaction between two devices with action and status indicators.

### Labels

6000A: John's device (e.g., a laptop)
6043: John's webcam bubble appears at the top-center position
6045: Top-center screen position where Jane's call request bubble appears
6044: Original position of Jane's video message bubble before moving
6047: Animation path indicating movement of Jane's video message bubble towards the top-center screen
6046: call ringing animation (e.g. shaking bubble), indicating the initiation of a ringing animation and sound when the called user is being notified
6048: Action menu displayed below Jane's call request bubble (e.g., appears on hover). Options include settings, canceling the call, or inviting more participants to join the call
6000B: Jane's device (e.g., a laptop)
6001B: Display.
6002B: One or more cameras
6003B: One or more microphones
6004B: Keyboard
6005B: Trackpad
6006B: Status bar
6049: Jane's Window 1 (e.g., sheet app or shared content space)
6011: Bubble messages status icon (e.g., opens bubble messages)
6012: Bubble messages app icon (e.g., opens bubble messages)
6013B: Dock
6014B: Desktop window
6015: Input (e.g., a mouse click)
6016B: Dynamic region
6017B: Sheet app icon
6050: John's call request bubble (displayed on Jane's screen on top of active windows)
6051: Incoming call animation (notifies the user of a call request e.g. shaking bubble)
6052: Action menu (providing options to accept, ignore, or adjust call settings)

### Description

FIG. 5 and FIG. 6 illustrate two devices collaborating or interacting with each other, namely device 6000A (John's Laptop) and device 6000B (Jane's Laptop).

On John's device (6000A), when John clicks “Calls” then Jane's video message bubble (6026) stops playing and moves from its original position (6044) towards the top-center of the screen, following the animation path (6047). Upon reaching the top-center position (6045), a ringing animation of Jane's video bubble optionally with sound (6046) begins, signaling an outgoing call to Jane. Simultaneously, John's webcam activates, placing his webcam bubble (6043) at the top-center position as well. In another embodiment more users can be displayed in a call. The bubbles will be aligned as an invisible grid in several rows next to each other. The action menu (6048) appears below Jane's call request bubble, providing options for managing the call, such as adjusting settings, canceling, or inviting more participants. When John cancels an outgoing call or ends an ongoing call then the video bubbles transition back to the previous display mode.

In FIG. 5, John initiates a call to Jane. On John's device (6000A), Jane's video message bubble (6044) transitions to the top-center position (6047) of the screen, accompanied by John's active webcam bubble (6048). A sound and animation path (6046) may indicate the initiation of the call, drawing attention to the incoming call request.

Simultaneously, on Jane's device (6000B), as seen in FIG. 6 John's call request bubble (6050) appears on top of her active windows (6049), displaying a notification animation (6051) that may include sound or visual effects to alert her of the call. The action menu (6052) below John's call bubble provides options for Jane to either “Accept” or “Ignore” the call, as well as adjust call settings, such as selecting her preferred camera and microphone.

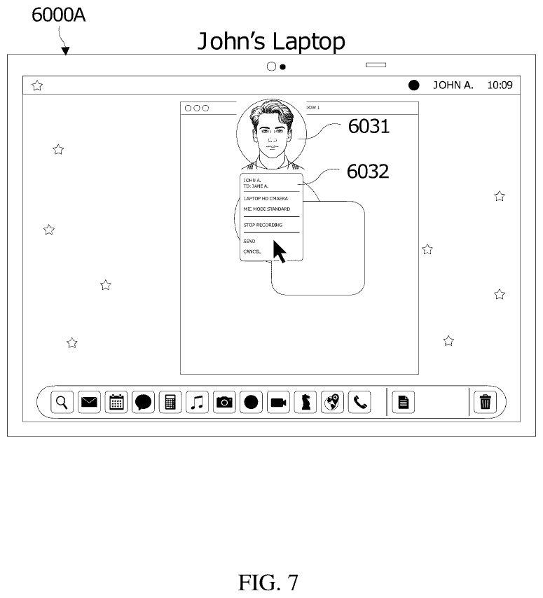

FIG. 7 depicts a video recording in progress with an action menu.

### Labels

6000A: John's device (e.g., a laptop)
6031: Video recording in progress (displays the user's video feed)
6032: Action menu overlay (appears on hover or user input, providing options like “Stop Recording,” “Send,” or “Cancel”)

### Description

FIG. 7 illustrates the video recording process on John's device (6000A). During recording, the user's video feed is displayed (6031), and an action menu overlay (6032) can be triggered by hovering or clicking within the recording area. This overlay provides options to manage the recording, including “Stop Recording” to pause or end the session, “Send” to finalize and send the recording, or “Cancel” to discard the recording.

If the user selects “Send,” the interface transitions to the next step, as depicted in the subsequent figure. The “Send To” field can be edited in this phase. In another embodiment, additional fields such as a “CC” field and a “Message Title” field are available for further customization before sending.

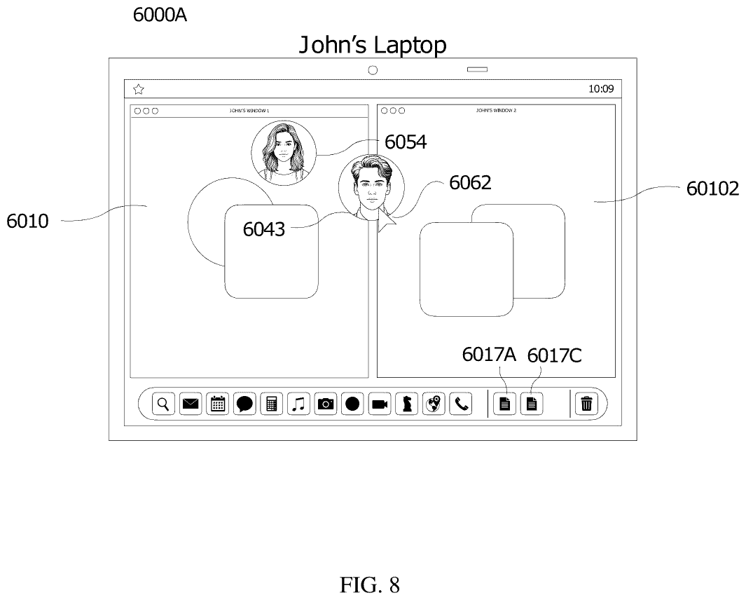

FIG. 8 illustrates a transition state where dragging call bubbles between windows is shown.

### Labels

6000A: John's device (e.g., a laptop)
6000B: Jane's device (e.g., a laptop)
6010: John's application Window 1 (currently shared)
60102: John's application Window 2 (not yet shared)
6043: John's call bubble (actively being dragged)
6054: Jane's call bubble (static, remains in its position)
6062: John's presenter pointer (active during drag action)
6061: Jane's default pointer
6017A: App icon for Window 1 in John's dynamic dock
6017C: App icon for Window 2 in John's dynamic dock

### Description

This figure depicts the transition state where John is dragging his call bubble (6043) from Window 1 (6010) to Window 2 (60102). The call bubble is partially overlapping both windows, with 50% in Window 1 and 50% in Window 2, indicating the midpoint of the drag transition.

On John's device (6000A), the interface demonstrates the intermediate state of moving his call bubble (6043) from Window 1 to Window 2. The 50% overlap visually signals the transition process between the two windows. If John stops dragging and releases the bubble, the system will snap it back to its original position in Window 1. This ensures intentional action by requiring a complete drag-and-drop motion.

On Jane's device, John's call bubble (6043) appears partially faded or semi-transparent, visually indicating that it is transitioning out of Window 1 and not fully available. Jane's call bubble (6054) and all other participants' bubbles remain static during the process.

Additional Embodiments: Bounce Back Behavior: If the drag action is interrupted (e.g., John releases the bubble before it fully enters Window 2), the bubble animates back to its starting position in Window 1. Group Call Bubble Movement: In another embodiment, dragging one call bubble (e.g., John's) could initiate a “chain reaction,” causing other participant bubbles to move as a group into the new window. Viewer Drag Option: Jane or other viewers could also be allowed to drag their call bubbles to another shared window. This action could trigger a transition process, allowing viewers to dynamically control which shared window they are anchored to. Call Bubble Positioning Settings: Users could configure drag behavior to snap call bubbles to predefined positions (e.g., corners, edges) within the new window. Visual Drag Path: The drag motion could be enhanced with visual cues, such as a dotted line or trail indicating the path of the dragged bubble. Multi-Bubble Chains: If multiple participants are grouped into a single bubble representing a group call, dragging this group bubble could distribute all individual bubbles into a new window, maintaining their relative positions. Automatic Sharing Prompt: If John completes the drag action into Window 2, the system could automatically prompt him to share the newly moved window, ensuring seamless continuity for the viewer.

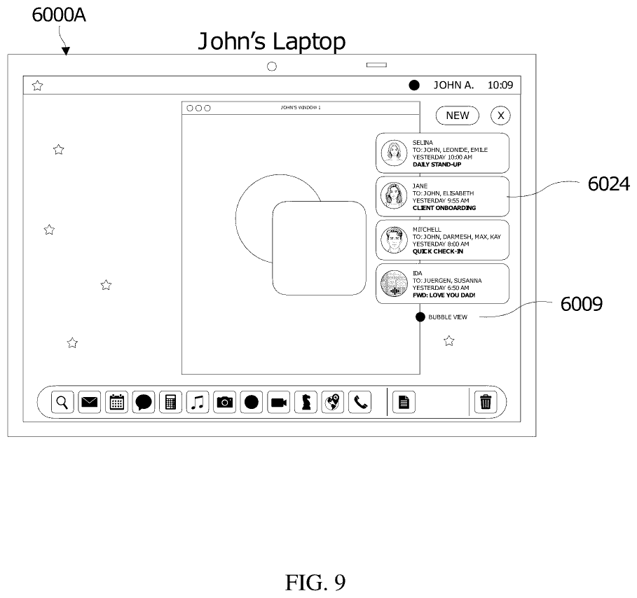

FIG. 9 illustrates a message preview overlay with toggle view options.

### Labels

6000A: John's device (e.g., a laptop)
6024: Message preview overlay (e.g., a list of recent messages showing sender, time, and a brief snippet of the content)
6009: Bubble message app toggle view overlay (e.g., allows toggling between bubble view and list view of messages)

### Description

FIG. 9 depicts the message preview interface on John's device (6000A). The message preview overlay (6024) displays a list of recent messages, providing details such as the sender, timestamp, and a short preview of the message content. The bubble message app toggle (6009) allows the user to switch between bubble view and list view seamlessly.

In another embodiment, the transitions between the bubbles and the notification/message bar are designed to be seamless. For example: The notification bar may fade out while the bubble scales up smoothly to open a detailed message view. A click or tap on a bubble could initiate a sliding animation to reveal the message's full content. If the user hovers over a bubble or message, a tooltip or quick actions menu (e.g., reply, delete, mark as read) could appear dynamically. The interface could also allow for swipe gestures to delete or archive messages directly from the preview.

In another embodiment, users can reorder messages within the list view by dragging and dropping them into a priority order or pinning specific messages to the top. Additionally, customizable transitions could enable themes or animations, such as scaling effects or unique animations for high-priority messages.

These embodiments aim to enhance the fluidity and interactivity of the message navigation experience.

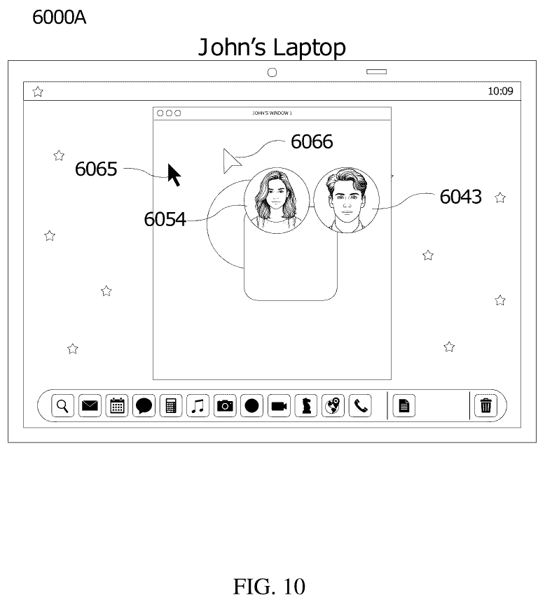

FIG. 10 illustrates a final state after presenter control transition.

### Labels

6000A: John's device (e.g., a laptop)
6000B: Jane's device (e.g., a laptop)
6043: John's call bubble
6054: Jane's call bubble
6065: John's default pointer (visible only to John)
6066: Jane's presenter pointer (fully active and visible to all participants)

### Description

This figure illustrates the final state after Jane takes over presenter control from John. The following key points highlight the end state: Presenter Control: Jane's pointer (6066) has fully transitioned into the active presenter pointer. It is visible to all participants and enables her to control the shared content. John's pointer (6065) is no longer controlling the shared content. It is visible only on John's screen and has reverted to a standard pointer appearance. Call Bubble Positions: Call bubbles have completed their slot transition, with Jane's call bubble (6054) occupying the presenter slot and John's call bubble (6043) shifting to the viewer position. All transitions and animations have been completed smoothly, ensuring clarity for all participants. Additional Embodiments: Visible Pointers for All Participants: In another embodiment, John's default pointer (6065) remains visible to all participants for enhanced collaboration, with a clear distinction (e.g., dimmed color or icon) to show it is no longer the active presenter pointer. Pointer Customization: Users can customize their pointers (e.g., colors, icons) to better indicate their role (presenter or viewer). Notification System: A system notification confirms the role Dynamic View Adjustments: In larger group settings, the interface dynamically adjusts the layout of call bubbles to accommodate the active presenter while keeping all participants visible.

This setup ensures a seamless and intuitive user experience for transitioning presenter control and maintaining clarity during collaborative sessions.

In another embodiment, users can turn off the “Follow Pointer” feature, allowing call bubbles to remain fixed in position rather than following the presenter pointer. When this feature is turned off, the interface transitions to a “Call Only View,” where call bubbles are statically aligned, independent of the presenter's movements. The presenter pointer can still operate freely across the shared content, but the call bubbles stay docked or in their last aligned position. This approach minimizes distractions caused by moving call bubbles.

Another embodiment allows the presenter or a viewer to hide their video bubble or all participants' video call bubbles using an option in the action menu. When all call bubbles are hidden, the menu bar or task bar provides an option to toggle the visibility of the call bubbles back on. Even in this hidden state, the presenter pointer remains visible and active to facilitate interactions. In this mode, a viewer can click directly on the presenter pointer to take control. The presenter cannot interact with viewer pointers since they remain invisible in this mode.

In an additional embodiment, viewer default pointers are visible to all participants, allowing the presenter to click on a viewer's pointer to transfer control. Upon clicking, the viewer's default pointer transitions into the presenter pointer, granting them control over the shared content. The previous presenter's pointer reverts to its default state. This ensures that the transfer of control is intentional and seamless.

Context-sensitive menus provide dynamic options based on the current view. For instance, in the “Call Only View,” the menu might include options for toggling call bubbles or switching to a shared content view. If call bubbles or pointers are hidden, the menu bar or task bar hosts an option to “Show Bubbles,” enabling users to toggle visibility easily. This adaptability ensures a smooth experience across different interaction modes.

If call bubbles or pointers are hidden, the presenter cannot interact with invisible elements like viewer pointers, ensuring clear boundaries of control and avoiding unintentional interactions. However, when viewer pointers are visible, the presenter can use them to delegate control intentionally.

Call bubble alignment dynamically adjusts based on user interactions or layout changes. When switching control or toggling video bubbles, the system aligns visible bubbles neatly within the shared window or at the edges of the screen. For example, bubbles may snap to predefined positions or adjust dynamically to avoid overlapping with shared content. If a bubble or pointer is dragged over a hidden window, the window automatically comes to the foreground, facilitating smoother workflows in multi-window setups.

To enhance the experience further, all transitions, such as pointer role changes, bubble visibility toggles, or control transfers, are accompanied by smooth animations and visual feedback. This may include a fade, bounce, or other visual effects to ensure users clearly understand what actions have occurred. These animations help prevent confusion during complex interactions.

In silent mode, pointer transitions and bubble movements occur without animations or notifications, making the system less distracting in professional or large group settings. This provides a clean and focused environment for high-priority tasks. These embodiments collectively aim to offer flexibility and seamless collaboration tailored to diverse user preferences and scenarios.

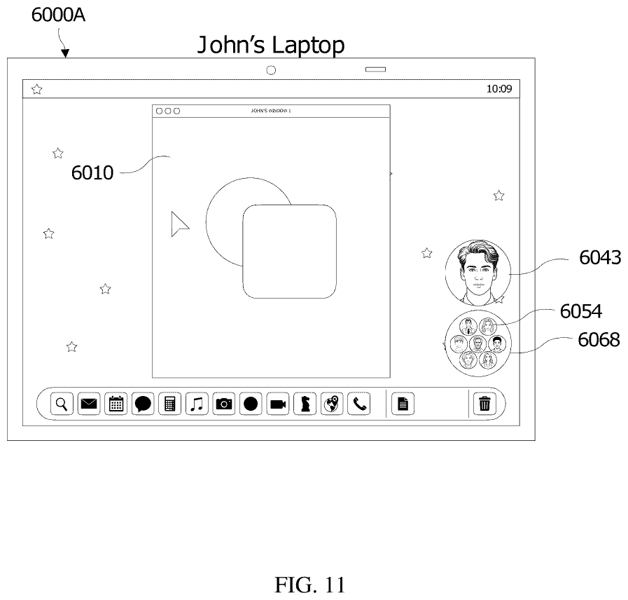

FIG. 11 illustrates non-shared screen setup with grouped call bubbles.

### Labels

6000A: John's device (e.g., a laptop)
6010: John's open application window (Window 1)
6061: Jane's default pointer
6043: John's call bubble in a main slot
6068: Grouped call bubbles (all participants except John)
6054: Jane's call bubble inside the grouped bubbles

### Description

This figure illustrates a non-shared screen setup where John (6000A) is working on his main application window (6010) without sharing it with other participants. John's call bubble (6043) occupies a primary slot on the screen, indicating his active presence in the call. The remaining participants, including Jane's call bubble (6054), are grouped into a composite bubble (6068) pinned to the bottom-right corner of the screen.

Additional Embodiments Hide or Self-Group: John can hide his call bubble or drag it into the grouped bubble (6068) to reduce visual clutter. Static Layout: All participants can remain grouped in a fixed position on the screen unless manually rearranged. Dynamic Arrangement: Users can rearrange individual call bubbles by dragging and dropping them into preferred positions on the screen. Custom Grouping: Participants can drag bubbles together to form custom groups or use a shortcut like “Command+G” to group them. Ungrouping: Call bubbles can be ungrouped by selecting a bubble and using a command or button to dissolve the group. Expandable Groups: Clicking on the grouped bubble expands it into a full display of all participants, either in an overlay or on a secondary display. Pinned Bubbles: Users can pin specific bubbles (e.g., speakers) to main slots for consistent visibility. Raise Hand and Queue: Participants can “raise their hand,” causing their bubbles to be dynamically prioritized in the group or moved into a queue outside the group. Silent Mode: Grouped bubbles can remain static without live video or audio until selected or expanded. Shortcut Customization: Shortcuts for grouping, ungrouping, and reordering bubbles can be customized for efficiency.

This setup is designed for efficient participation in large calls, allowing users to maintain focus on their primary tasks while keeping track of other participants through the grouped call bubbles.

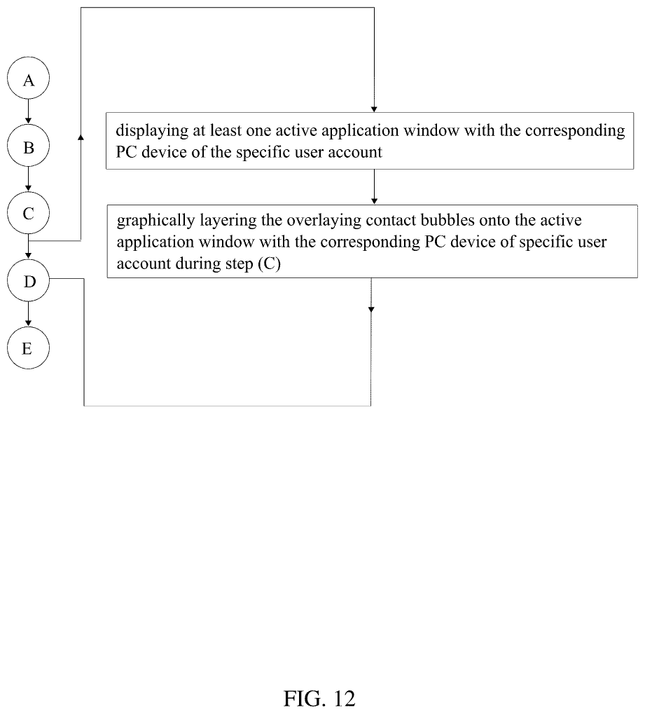

In reference to FIG. 12, one subprocess for the method of the present invention begins by displaying at least one active application window with the corresponding PC device of the specific user account. This subprocess continues by graphically layering the overlaying contact bubbles onto the active application window with the corresponding PC device of specific user account during Step C. In other words, the interactive overlay bubbles integrate into websites through embeddable overlays, providing persistent bubbles for ongoing conversations, aligned with website content (e.g., product details or customer support pages). More specifically, the contact bubbles may be layered over other active windows enabling real-time annotations, discussions, and collaborations.

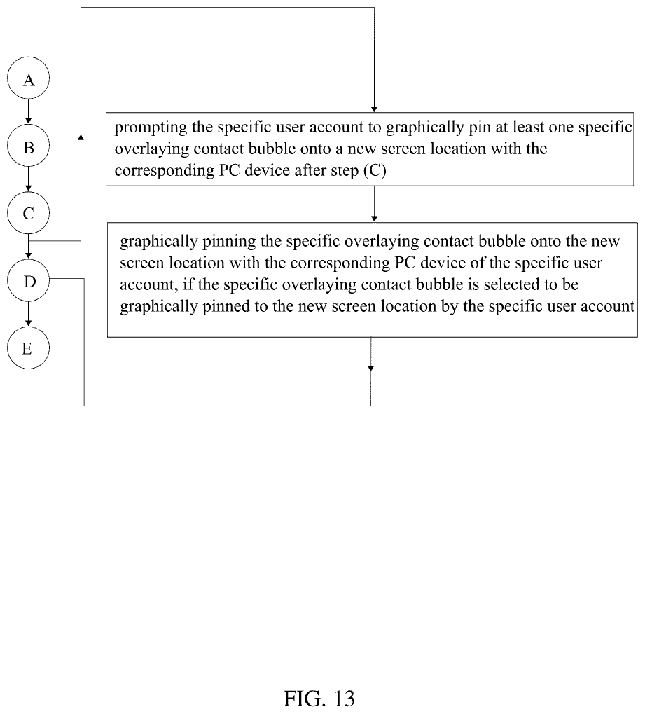

In reference to FIG. 13, another subprocess for the method of the present invention begins by prompting the specific user account to graphically pin at least one specific overlaying contact bubble onto a new screen location with the corresponding PC device after Step C, wherein the specific overlaying contact bubble is from the plurality of overlaying contact bubbles. This subprocess continues by graphically pinning the specific overlaying contact bubble onto the new screen location with the corresponding PC device of the specific user account, if the specific overlaying contact bubble is selected to be graphically pinned to the new screen location by the specific user account. Thus, the present invention allows users to graphically pin and move the overlaying contacting bubble as needed. More specifically, the interactive contact bubbles transition between states dynamically based on user actions, including switching between asynchronous message display (e.g., recorded video or text) and synchronous interaction (e.g., live call or screen sharing), automatically adapting their size, position, or visibility when the user changes the active application or workspace, etc. In other words, the present invention enables dynamic transitions, adaptive layouts, or seamless mode changes for the overlay interface during various communication interactions.

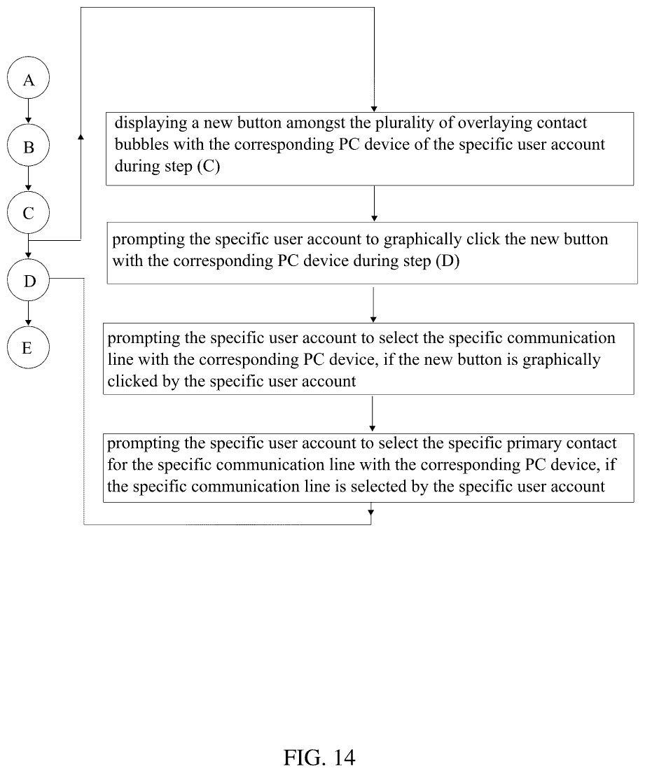

In reference to FIG. 14, another subprocess for the method of the present invention begins by displaying a new button amongst the plurality of overlaying contact bubbles with the corresponding PC device of the specific user account during Step C. This subprocess continues by prompting the specific user account to graphically click the new button with the corresponding PC device during Step D. Further, this subprocess continues by prompting the specific user account to select the specific communication line with the corresponding PC device, if the new button is graphically clicked by the specific user account. Furthermore, this subprocess continues by prompting the specific user account to select the specific primary contact for the specific communication line with the corresponding PC device, if the specific communication line is selected by the specific user account. For example, a user is able to graphically interact with the new button in order to initiate a new communication or a different new action. Upon clicking the new button, an action-menu overlay appears on the GUI and displays various options including, but is not limited to, sending a video message, recording an audio message, starting a screen recording, initiating a video or audio call, sharing a screen or file, and creating a group for communication.

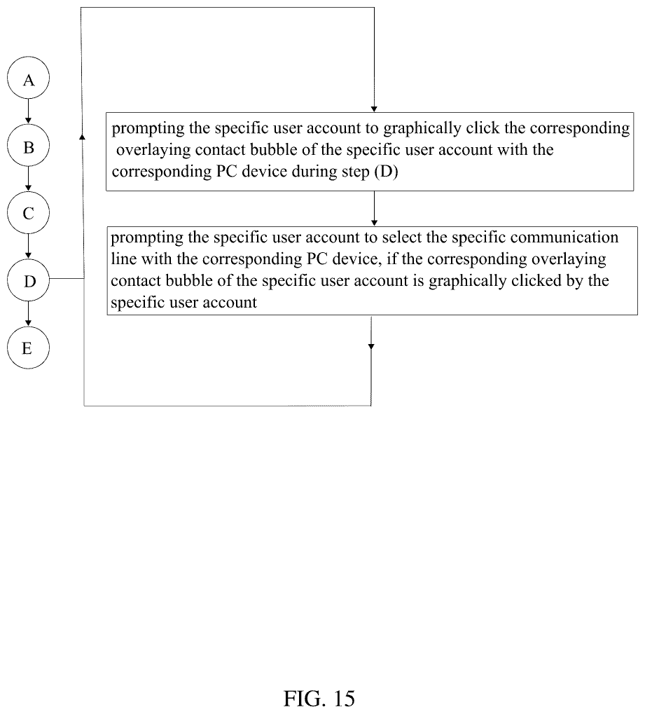

In reference to FIG. 15, another subprocess for the method of the present invention begins by prompting the specific user account to graphically click the corresponding overlaying contact bubble of the specific user account with the corresponding PC device during Step D. This subprocess continues by prompting the specific user account to select the specific communication line with the corresponding PC device, if the corresponding overlaying contact bubble of the specific user account is graphically clicked by the specific user account. In other words, users can interact with a specific contact by clicking on that specific user's contact bubble. In some embodiments, the present invention allows a user to view content such as a profile photo with audio, video, or screen recording. The user can click on an overlaying contact bubble in order to graphically interact with the message options, which activates an action-menu overlay and consequently provides a range of actions like replying with different formats (video, audio, screen recording), initiating a video or audio call, or sharing the screen.

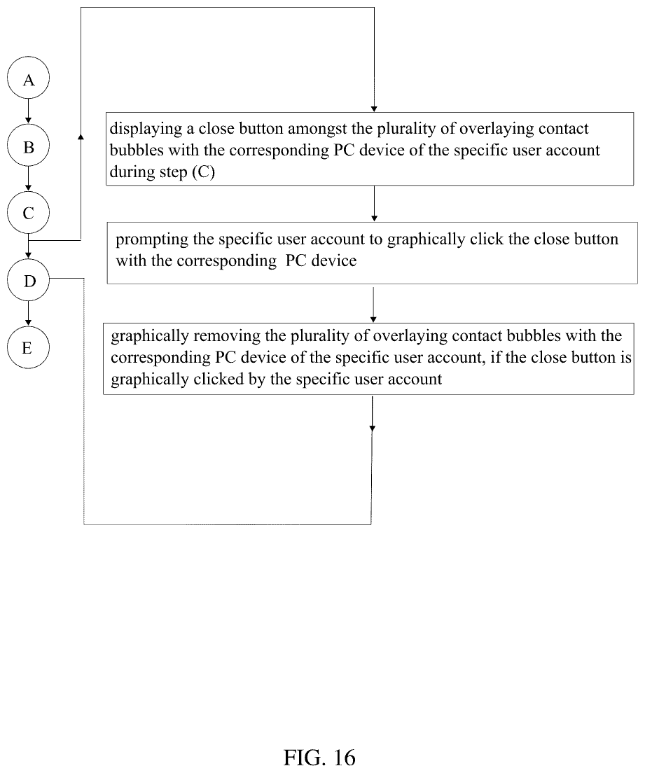

In reference to FIG. 16 another subprocess for the method of the present invention begins by displaying a close button amongst the plurality of overlaying contact bubbles with the corresponding PC device of the specific user account during Step C. This subprocess continues by prompting the specific user account to graphically click the close button with the corresponding PC device. Subsequently, this subprocess continues by graphically removing the overlaying contact bubbles with the corresponding PC device of the specific user account, if the close button is graphically clicked by the specific user account. In other words, the present invention allows a user to remove the overlaying contact bubbles from their view and/or to close other actions related to the overlaying contact bubbles.

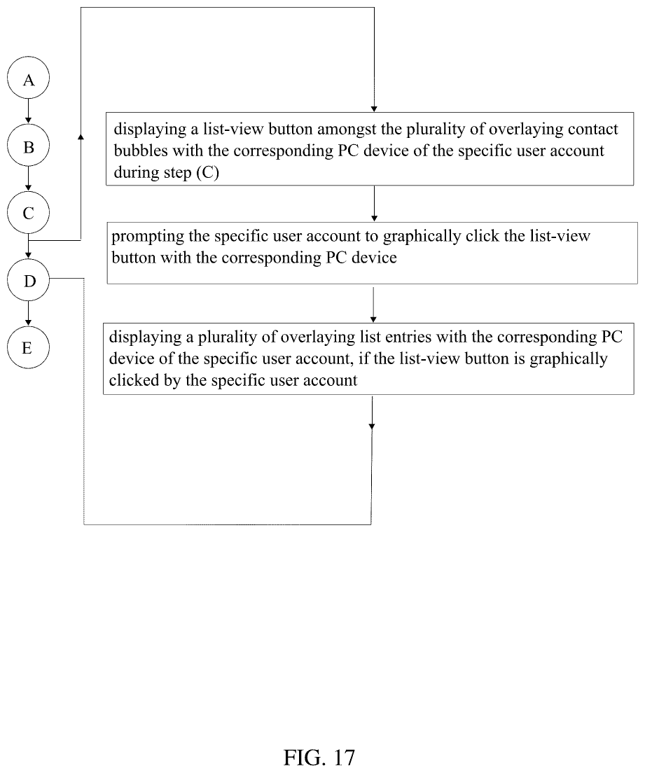

In reference to FIG. 17, another subprocess for the method of the present invention begins by displaying a list-view button amongst the plurality of overlaying contact bubbles with the corresponding PC device of the specific user account during Step C. This subprocess continues by prompting the specific user account to graphically click the list-view button with the corresponding PC device. This subprocess continues by displaying a plurality of overlaying list entries with the corresponding PC device of the specific user account, if the list-view button is graphically clicked by the specific user account, and wherein each primary contact for the specific user account is displayed as a corresponding overlaying list entry from the plurality of overlaying list entries. In other words, the present invention allows a user to view their primary contacts as overlaying list entries by clicking the list-view button instead of viewing their primary contacts as the overlaying contact bubbles.

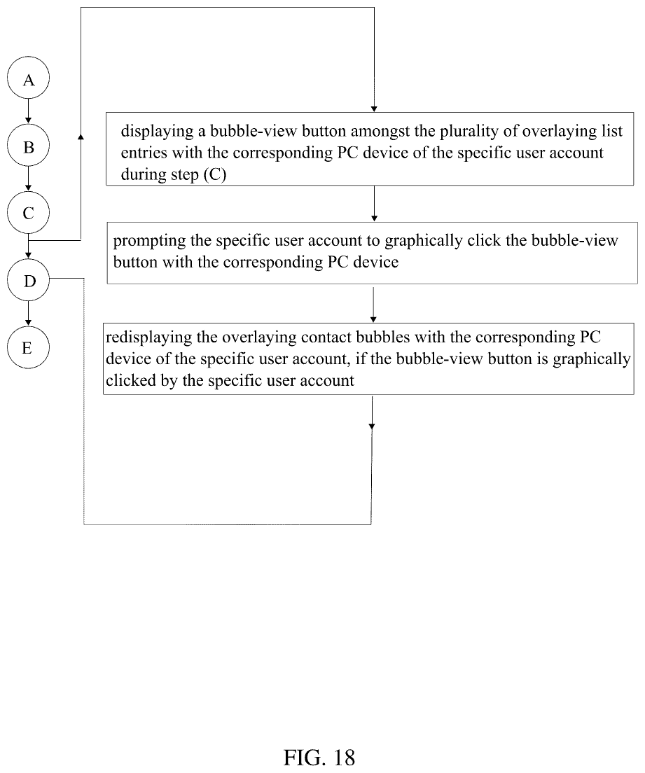

In reference to FIG. 18, when the overlaying list entries are being displayed with the corresponding PC device of the specific user account, another subprocess for the method of the present invention begins by displaying a bubble-view button amongst the plurality of overlaying list entries with the corresponding PC device of the specific user account during Step C. This subprocess continues by prompting the specific user account to graphically click the bubble-view button with the corresponding PC device. Further, this subprocess continues by redisplaying the overlaying contact bubbles with the corresponding PC device of the specific user account, if the bubble-view button is graphically clicked by the specific user account. In other words, the present invention allows a user to return to viewing their primary contacts as overlaying contact bubbles by clicking the bubble-view button instead of viewing their primary contacts as the overlaying list entries.

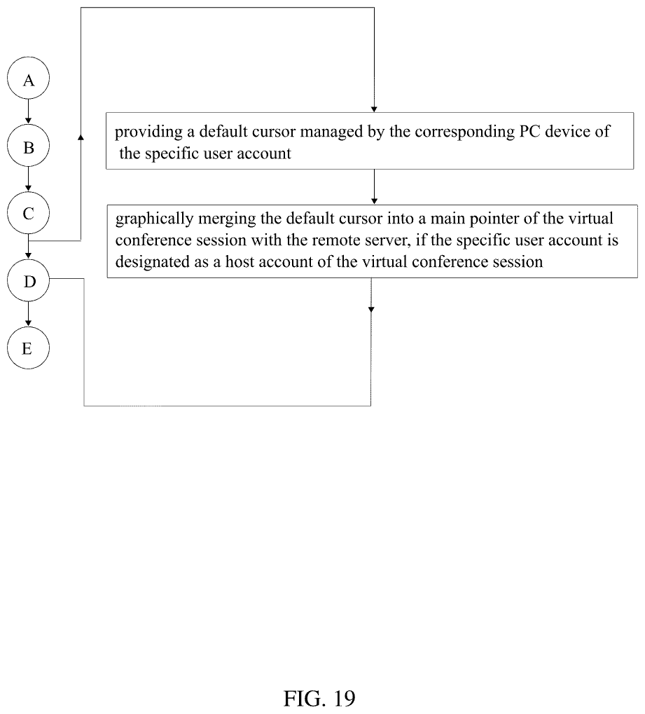

In reference to FIG. 19, when the specific communication line is a virtual conference session held between the specific user account and the other user account, another subprocess for the method of the present invention is provided with a default cursor managed by the corresponding PC device of the specific user account. This subprocess begins by graphically merging the default cursor into a main pointer of the virtual conference session with the remote server, if the specific user account is designated as a host account of the virtual conference session. For example, during an interaction, the specific user may have control over the main pointer during a virtual conference session. In order to attain this control, an action menu available on the specific user's overlay allows the user to adjust settings related to screen-sharing session. Activating a “follow presenter pointer” option transitions the user's default pointer into the main pointer. However, if the control of the screen sharing session is transferred or possessed by a different user from the contact list of the user account or a participant of the screen sharing session, then the default pointer of that participant merges into the main pointer. In some embodiments, this subprocess includes handing over control of the main pointer to other user accounts attending the virtual conference session and/or customizing the main pointer in its graphic appearance (e.g., its size, its color coding, etc.).

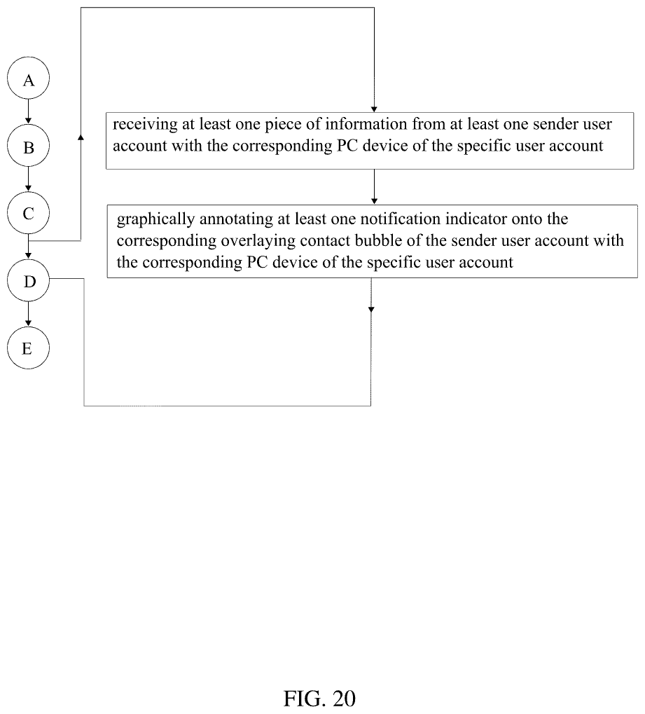

In reference to FIG. 20, another subprocess for the method of the present invention begins by receiving at least one piece of information from at least one sender user account with the corresponding PC device of the specific user account, wherein the sender user account is from the plurality of user accounts. This subprocess continues by graphically annotating at least one notification indicator onto the corresponding overlaying contact bubble of the sender user account with the corresponding PC device of the specific user account, wherein the notification indicator is associated to the piece of information. In other words, the present invention enables the overlaying contact bubble to carry a notification indicator to indicate the arrival of a new message. For example, as seen in FIG. 2, the notification indicator is a paper clip sign to indicate an attachment, a voice signal to indicate a voice message, or a blinking bubble to indicate a new video recording. It should be noted that the notification indicator can be any other signs, symbols, or visual indicator, as long as the intents of the present invention are not altered.

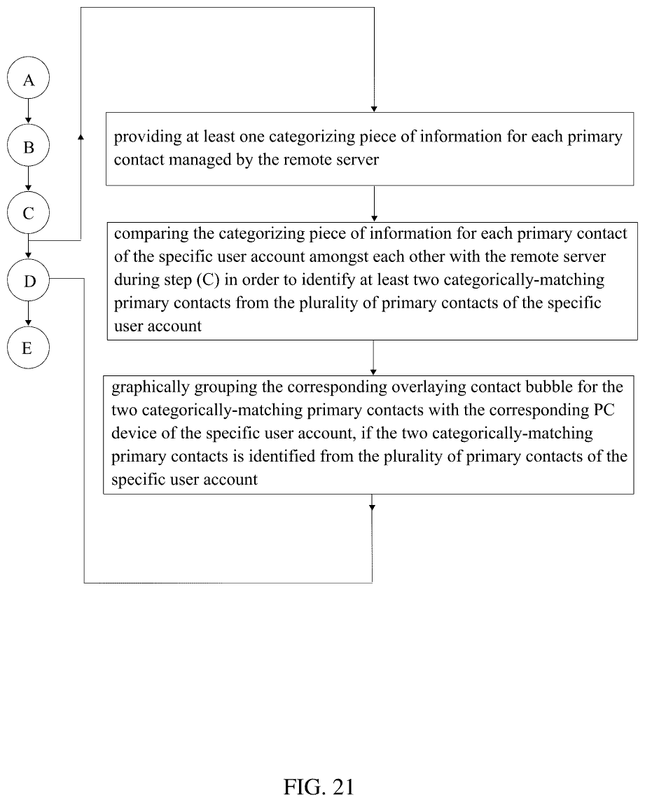

In reference to FIG. 21, another subprocess for the method of the present invention is provided with at least one categorizing piece of information for each primary contact managed by the remote server, which allows for an automated dynamic grouping of a user's primary contact. A categorizing piece of information can be, but is not limited to, at least two primary contacts engaging in the same topic, at least two primary contacts being participants in the same gathering, or at least two primary contacts sharing the same task. This subprocess continues by comparing the categorizing piece of information for each primary contact of the specific user account amongst each other with the remote server during Step C in order to identify at least two categorically-matching primary contacts from the plurality of primary contacts of the specific user account. This subprocess concludes by graphically grouping the corresponding overlaying contact bubble for the two categorically-matching primary contacts with the corresponding PC device of the specific user account, if the two categorically-matching primary contacts is identified from the plurality of primary contacts of the specific user account. For example, this subprocess visually groups at least two of their primary contacts for a user together for some reason determined by the remote server (e.g., at least two primary contacts sharing the same professional field, at least two primary contacts being on the same work project, at least two primary contacts being members at the same social club, etc.).

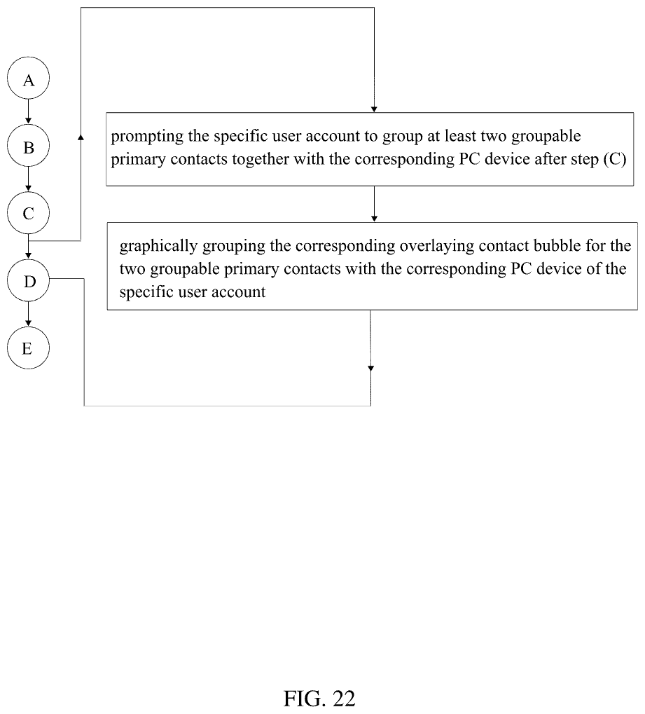

In reference to FIG. 22, another subprocess for the method of the present invention begins by prompting the specific user account to group at least two groupable primary contacts together with the corresponding PC device after Step C, which allows for a user-initiated grouping of a user's primary contacts. This user-initiated grouping can be prompted through a GUI by dragging one overlaying contact bubble onto another overlaying contact bubble, selecting multiple overlaying contact bubbles, or creating a designated group area for at least two overlaying contact bubbles. Moreover, the two groupable primary contacts are from the plurality of primary contacts of the specific user account. This subprocess concludes by graphically grouping the corresponding overlaying contact bubble for the two groupable primary contacts with the corresponding PC device of the specific user account. For example, this subprocess allows a user to visually group at least two of their primary contacts together for some reason determined by the user (e.g., a project being worked on by the user and at least two of their primary contacts, a social gathering being planned and/or attended by the user and at least two of their primary contacts, a family chat being engaged by the user and at least two of their primary contacts, etc.).

Another subprocess for the method of the present invention allows at least one body gesture to be received by the corresponding PC device of the specific user account as at least one prompt-entering feature for the overlaying contact bubbles. The prompt-entering feature can be, but is not limited to, position control (e.g., moving up, down, left, or right on a screen). The body gesture allows for moving bubbles, sharing screens, or grouping bubbles.

The following are some additional features of the present invention: the overlaying contact bubbles dynamically adapt their position, size, or layout based on a screen size, device type, or user interface context of the corresponding computing device; the user interface context comprises reading direction, an active application window, or a change in display orientation of the corresponding computing device; the overlaying contact bubbles include a privacy control feature that restricts visibility of specific bubbles using password protection, encryption, or access permissions; a hidden overlaying contact bubble remains concealed until a specific authentication action, comprising a password entry, biometric input, or authorized gesture, is performed by the specific user account; the overlaying contact bubbles are configured to be repositioned dynamically across multiple screens of a multi-monitor environment associated with the corresponding computing device; and the overlaying contact bubbles are configured to automatically adjust their visibility and placement when a shared screen session is initiated or terminated.

Although the invention has been explained in relation to its preferred embodiment, it is to be understood that many other possible modifications and variations can be made without departing from the spirit and scope of the invention.

What is claimed is:

1. A method of managing a graphic user interface (GUI) for a messaging service with overlaying contact bubbles, the method comprising the steps of:
(A) providing a plurality of communication lines and a plurality of user accounts managed by at least one remote server, wherein each user account is associated with a corresponding personal computing (PC) device, and wherein each user account includes user-identifying visual information and a plurality of primary contacts, and wherein each primary contact is associated to a corresponding user account from the plurality of user accounts;
(B) prompting each user account to view a plurality of overlaying contact bubbles with the corresponding PC device;
(C) displaying the overlaying contact bubbles with the corresponding PC device of at least one specific user account, if the overlaying contact bubbles is selected to be viewed by the specific user account, wherein the specific user account is from the plurality of user accounts, and wherein the user-identifying visual information of each primary contact for the specific user account is displayed within a corresponding overlaying contact bubble from the plurality of overlaying contact bubbles;
(D) prompting the specific user account to select at least one specific communication line for at least one specific primary contact with the corresponding PC device, wherein the specific communication line is from the plurality of communication lines, and wherein the specific primary contact is from the plurality of primary contacts for the specific user account; and
(E) managing the specific communication line between the specific user account and at least one other user account through the remote server, wherein the other user account is the corresponding user account of the specific user contact.

2. The method as claimed in claim 1 comprising the steps of:
displaying at least one active application window with the corresponding PC device of the specific user account; and
graphically layering the overlaying contact bubbles onto the active application window with the corresponding PC device of specific user account during step (C).

3. The method as claimed in claim 1 comprising the steps of:
prompting the specific user account to graphically pin at least one specific overlaying contact bubble onto a new screen location with the corresponding PC device after step (C), wherein the specific overlaying contact bubble is from the plurality of overlaying contact bubbles; and
graphically pinning the specific overlaying contact bubble onto the new screen location with the corresponding PC device of the specific user account, if the specific overlaying contact bubble is selected to be graphically pinned to the new screen location by the specific user account.

4. The method as claimed in claim 1 comprising the steps of:
displaying a new button amongst the plurality of overlaying contact bubbles with the corresponding PC device of the specific user account during step (C);
prompting the specific user account to graphically click the new button with the corresponding PC device during step (D);
prompting the specific user account to select the specific communication line with the corresponding PC device, if the new button is graphically clicked by the specific user account; and
prompting the specific user account to select the specific primary contact for the specific communication line with the corresponding PC device, if the specific communication line is selected by the specific user account.

5. The method as claimed in claim 1 comprising the steps of:
prompting the specific user account to graphically click the corresponding overlaying contact bubble of the specific user account with the corresponding PC device during step (D); and
prompting the specific user account to select the specific communication line with the corresponding PC device, if the corresponding overlaying contact bubble of the specific user account is graphically clicked by the specific user account.

6. The method as claimed in claim 1 comprising the steps of:
displaying a close button amongst the plurality of overlaying contact bubbles with the corresponding PC device of the specific user account during step (C);
prompting the specific user account to graphically click the close button with the corresponding PC device; and
graphically removing the overlaying contact bubbles with the corresponding PC device of the specific user account, if the close button is graphically clicked by the specific user account.

7. The method as claimed in claim 1 comprising the steps of:
displaying a list-view button amongst the plurality of overlaying contact bubbles with the corresponding PC device of the specific user account during step (C);
prompting the specific user account to graphically click the list-view button with the corresponding PC device; and
displaying a plurality of overlaying list entries with the corresponding PC device of the specific user account, if the list-view button is graphically clicked by the specific user account, and wherein each primary contact for the specific user account is displayed as a corresponding overlaying list entry from the plurality of overlaying list entries.

8. The method as claimed in claim 7 comprising the steps of:
displaying a bubble-view button amongst the plurality of overlaying list entries with the corresponding PC device of the specific user account during step (C);
prompting the specific user account to graphically click the bubble-view button with the corresponding PC device; and
redisplaying the overlaying contact bubbles with the corresponding PC device of the specific user account, if the bubble-view button is graphically clicked by the specific user account.

9. The method as claimed in claim 1, wherein the specific communication line is at least one textual message sent between the specific user account and the other user account during step (E).

10. The method as claimed in claim 1, wherein the specific communication line is at least one video message sent between the specific user account and the other user account during step (E).

11. The method as claimed in claim 1, wherein the specific communication line is at least one audio message sent between the specific user account and the other user account during step (E).

12. The method as claimed in claim 1, wherein the specific communication line is a virtual conference session held between the specific user account and the other user account during step (E).

13. The method as claimed in claim 1 comprising the steps of:
providing a default cursor managed by the corresponding PC device of the specific user account; and
graphically merging the default cursor into a main pointer of the virtual conference session with the remote server, if the specific user account is designated as a host account of the virtual conference session.

14. The method as claimed in claim 1 comprising the steps of:
receiving at least one piece of information from at least one sender user account with the corresponding PC device of the specific user account, wherein the sender user account is from the plurality of user accounts; and
graphically annotating at least one notification indicator onto the corresponding overlaying contact bubble of the sender user account with the corresponding PC device of the specific user account, wherein the notification indicator is associated to the piece of information.

15. The method as claimed in claim 1 comprising the steps of:
providing at least one categorizing piece of information for each primary contact managed by the remote server;
comparing the categorizing piece of information for each primary contact of the specific user account amongst each other with the remote server during step (C) in order to identify at least two categorically-matching primary contacts from the plurality of primary contacts of the specific user account; and
graphically grouping the corresponding overlaying contact bubble for the two categorically-matching primary contacts with the corresponding PC device of the specific user account, if the two categorically-matching primary contacts is identified from the plurality of primary contacts of the specific user account.

16. The method as claimed in claim 1 comprising the steps of:
prompting the specific user account to group at least two groupable primary contacts together with the corresponding PC device after step (C), wherein the two groupable primary contacts are from the plurality of primary contacts of the specific user account; and
graphically grouping the corresponding overlaying contact bubble for the two groupable primary contacts with the corresponding PC device of the specific user account.

17. The method as claimed in claim 1, wherein a graphic seamless transition is executed by the remote server or the corresponding PC device of the specific user account while switching from the specific communication line to another communication line, if the specific user account selects to switch from the specific communication line to the other communication line, wherein the other communication line is from the plurality of communication lines.

18. The method as claimed in claim 1, wherein artificial intelligence model is managed by the remote server or the corresponding PC device of the specific user account, and wherein at least one response, at least one transcription, at least one summary, or a combination thereof is generated by the artificial intelligence model.

19. The method as claimed in claim 1, wherein at least one body gesture is received by the corresponding PC device of the specific user account as at least one prompt-entering feature for the overlaying contact bubbles.
